(19) United States
(12) Patent Application Publication
(10) Pub. No.: US 2012/0218231 A1
(43) Pub. Date: Aug. 30, 2012

(54) Electronic Device and Method for Calibration of a Touch Screen

(75) Inventors: Jiri Slaby, Buffalo Grove, IL (US); Roger W. Ady, Chicago, IL (US); John Krahenbuhl, McHenry, IL (US)

(73) Assignee: Motorola Mobility, Inc., Libertyville, IL (US)

(21) Appl. No.: 13/036,773

(22) Filed: Feb. 28, 2011

(51) Int. Cl. G06F 3/041

(52) U.S. Cl. 345/178

(57) ABSTRACT

There is provided an electronic device and method for calibration of a touch screen using a biometric sensor. The touch screen includes a display and a touch sensor associated with the display. The biometric sensor is configured to detect a user input. The display and/or the touch sensor of the touch screen are calibrated based on the user input detected at the biometric sensor.

### FIELD OF THE INVENTION

The present invention relates generally to the field of electronic devices having touch screens and, more particularly, to the field of electronic devices that calibrate the performance of touch screens to provide a positive user experience.

### BACKGROUND OF THE INVENTION

Many electronic devices, such as smart phones, may include a touch screen as a user interface for data input and output. A touch screen is a combination of a visual display and a touch sensitive surface that work in conjunction with each other. User contact at the touch sensitive surface is correlated with a particular presence and location within the display area of the display. Users commonly use a finger or stylus to contact the touch sensitive surface of the touch screen.

Users are increasingly dependent on accurate and crisp touch screen interactions to drive the latest generation of mobile devices. This need is further heightened by the variety of device configurations available to the users. Some of the trends relating to device configurations include the gradual removal of dedicated navigation keys or joysticks, the gradual increase in the use of sophisticated finger gestures (multi-finger, finger force sensing, etc.), and the continued advancement toward higher resolution displays, which results in smaller and more tightly clustered icons and web links on screen. The problem is that a one-size-fits-all response to user input does not always result in the best user experience for the majority of users.

Different users may have different size fingers or styluses to contact the touch sensitive surface of the touch screen. As a result, each user may desire calibration or otherwise special setup of the user's interaction with the touch screen. Calibration of user input to the user's touch screen device may lead to a better, more efficient user experience.

### BRIEF DESCRIPTION OF THE DRAWINGS

FIG. 1 is a planar view of an embodiment in accordance with the present invention.

FIG. 2 is a block diagram of example components of the embodiment of FIG. 1.

FIGS. 3A and 3B are screen views illustrating an example operation of an embodiment based on a larger object detected at the biometric sensor.

FIGS. 4A and 4B are screen views illustrating the example operation of FIGS. 3A and 3B based on a smaller object detected at the biometric sensor.

FIGS. 5A and 5B are screen views illustrating an example operation of another embodiment based on a larger object detected at the biometric sensor.

FIGS. 6A and 6B are screen views illustrating the example operation of FIGS. 5A and 5B based on a smaller object detected at the biometric sensor.

FIGS. 7A and 7B are screen views illustrating an example operation of yet another embodiment in accordance with the present invention.

FIG. 8 is a flow diagram representing an example operation of still another embodiment in accordance with the present invention.

FIG. 9 is a planar view of another embodiment in accordance with the present invention.

FIG. 10 is a planar view of yet another embodiment in accordance with the present invention.

### DETAILED DESCRIPTION OF THE EMBODIMENTS

There is disclosed is a device and method for allowing calibration of a touch screen sensor or display using biometric data from the biometric (for example, fingerprint) sensor or reader on devices that have such readers. The biometric data on one or more specific digits or objects can be accurately collected and continuously refined for several individual users.

One aspect of the present invention is an electronic device having a user interface, in which the electronic device is capable of calibrating the user interface. The device comprises a biometric sensor, a touch screen, and at least one processor. The biometric sensor is configured to detect a user input. The touch screen includes a display and a touch sensor associated with the display. The processor or processors are configured to calibrate at least one of the display or the touch sensor of the touch screen based on the user input detected at the biometric sensor.

Another aspect of the present invention is a method of an electronic device for calibration of a touch screen using a biometric sensor. A user input is detected at the biometric sensor. The touch screen is configured in response to detecting the user input at the biometric sensor.

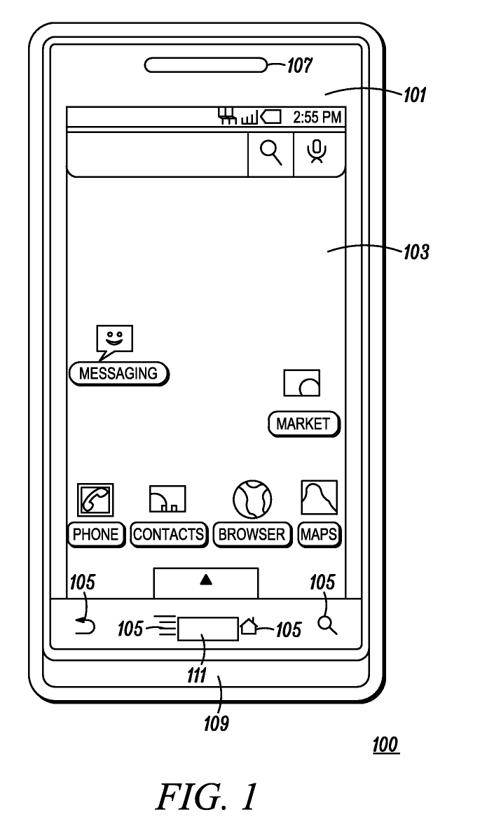

Referring to FIG. 1, there is illustrated a perspective view of an example portable electronic device 100 in accordance with the present invention. The device 100 may be any type of device capable of providing touch screen interactive capabilities. Examples of the portable electronic device 100 include, but are not limited to, mobile device, wireless devices, tablet computing devices, personal digital assistants, personal navigation devices, touch screen input device, touch or pen-based input devices, portable video and/or audio players, and the like. It is to be understood that the portable electronic device 100 may take the form of a variety of form factors, such as, but not limited to, bar, tablet, flip/clam, slider and rotator form factors.

For one embodiment, the portable electronic device 100 has a housing comprising a front surface 101 which includes a visible display 103 and a user interface. For example, the user interface may be a touch screen including a touch-sensitive surface that overlays the display 103. For another embodiment, the user interface or touch screen of the portable electronic device 100 may include a touch-sensitive surface supported by the housing that does not overlay any type of display. For yet another embodiment, the user interface of the portable electronic device 100 may include one or more input keys 105. Examples of the input key or keys 105 include, but are not limited to, keys of an alpha or numeric keypad or keyboard, a physical keys, touch-sensitive surfaces, mechanical surfaces, multipoint directional keys and side buttons 105. The portable electronic device 100 may also comprise apertures 107, 109 for audio output and input at the surface. It is to be understood that the portable electronic device 100 may include a variety of different combination of displays and interfaces.

The present invention includes a biometric sensor 111, such as a fingerprint sensor. A biometric sensor 111 is an input device capable of capturing a digital image of an object scanned by the sensor. For example, a fingerprint sensor is a special type of biometric sensor that captures a digital image of an end portion of a human finger. Specifically, a fingerprint pattern of the finger is captured by the fingerprint sensor and, thereafter, processed by associated equipment to recreate a biometric template corresponding to the finger. Biometric sensors, such as fingerprint sensors, may utilize optical, ultrasonic, capacitive, RF imaging, or other technologies to capture the digital image.

The biometric sensor 111 may be used to estimate a user's finger (or other object) characteristics based on the image size and/or shape captured during a typical user scan or swipe action. Using the finger characteristic, such as a size estimate of the finger, the touch screen sensitivity and target size is optimized for that measured data.

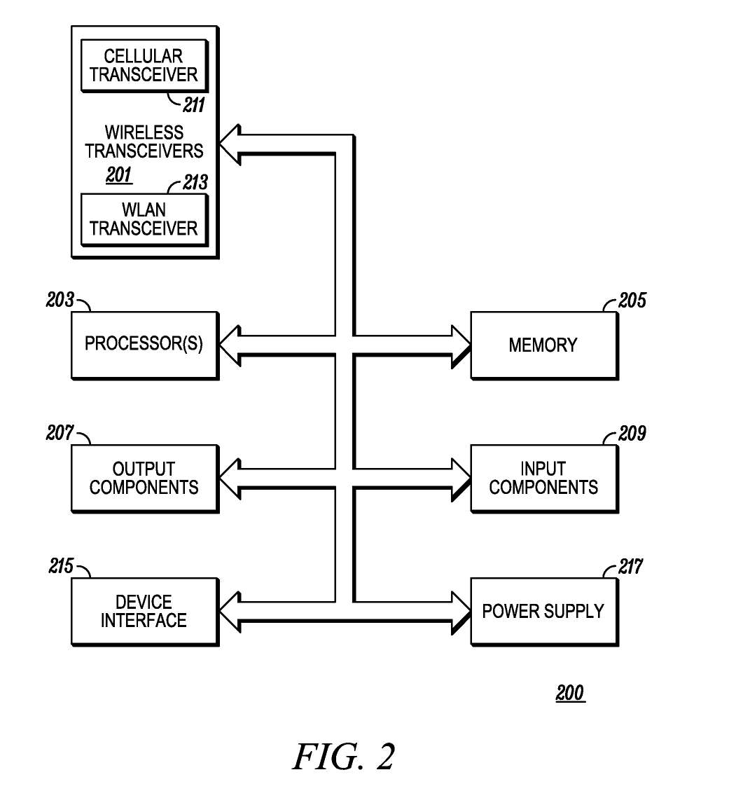

Referring to FIG. 2, there is shown a block diagram representing example components that may be used for an embodiment in accordance with the present invention. The example embodiment may include one or more wireless transceivers 201, one or more processors 203, one or more memories 205, one or more output components 207, and one or more input components 209. Each embodiment may include a user interface that comprises one or more output components 207 and one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 311. Each wireless transceiver 201 may also utilize wireless technology for communication, such as, but are not limited to, peer-to-peer or ad hoc communications such as HomeRF, Bluetooth and IEEE 802.11 (a, b, g or n), wireless HDMI; wireless USB, and other forms of wireless communication such as infrared technology, as represented by WLAN transceiver 213. Also, each transceiver 201 may be a receiver, a transmitter or both.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device, such as interaction among the components of the internal components 200, communication with external devices via each transceiver 201 and/or the device interface (see below), and storage and retrieval of applications and data to and from the memory 205. Each application includes executable code utilizing an operating system to provide more specific functionality for the portable electronic device. Also, the processor is capable of executing an application associated with a particular widget shown at an output component 207. Data is non-executable code or information that may be referenced and/or manipulated by an operating system or application for performing functions of the portable electronic device.

The memory 205 may include various modules to structure or otherwise facilitate certain operations in accordance with the present invention. The memory 205 may include a configuration manager module that configures the touch sensor sensitivity and icon/image size based on the biometric size data (for example, data reflecting finger size) detected by the biometric sensor. Subsequently, the configuration manager module may refine the calibration based on statistical evaluation of the image size data collected from user activity, such as a user's logins records or user interface entries. The memory 206 may also include a calibration manager module. A displayed image may be calibrated based on the biometric size data detected by the biometric sensor. The expected size may be refined depending on the user style as their finger use may differ (thumb, index finger, etc.). The calibration manager module may calibrate the icon/image sized based on the most-recently collected data.

The input components 209, such as the biometric sensor 111, the touch sensitive surface of the touch screen, or other components of the user interface, may produce an input signal in response to detecting a gesture, such as a scan or swipe. In addition, the input components 209 may include one or more additional components, such as a video input component such as an optical sensor (for example, a camera), an audio input component such as a microphone, and a mechanical input component or activator such as button or key selection sensors, touch pad sensor, another touch-sensitive sensor, capacitive sensor, motion sensor, and switch. Likewise, the output components 207 of the internal components 200 may include one or more video, audio and/or mechanical outputs. For example, the output components 207 may include the visible display 103 of the touch screen. Other output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

The internal components 200 may further include a device interface 215 to provide a direct connection to auxiliary components or accessories for additional or enhanced functionality. In addition, the internal components 200 preferably include a power source 217, such as a portable battery, for providing power to the other internal components and allow portability of the portable electronic device 100.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

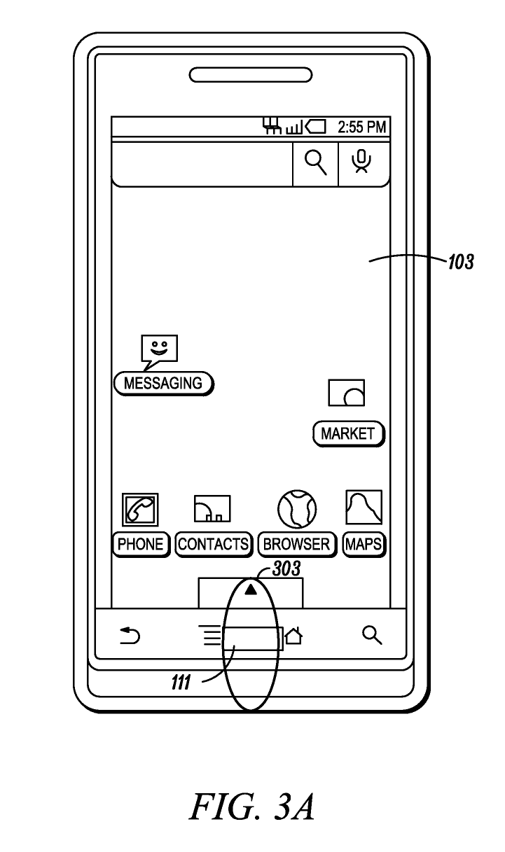

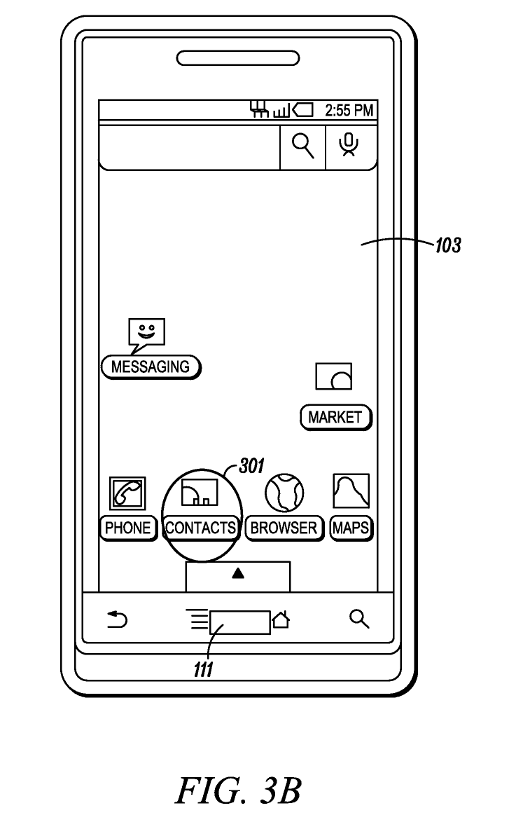

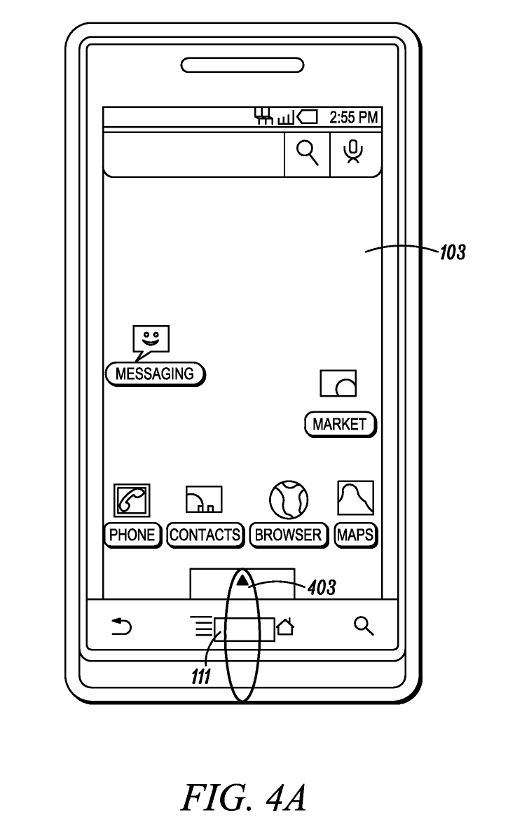

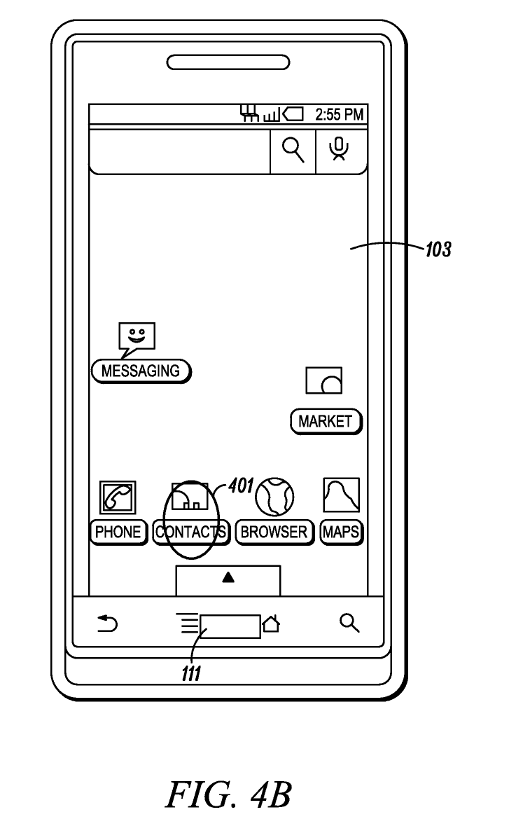

Referring to FIGS. 3A, 3B, 4A and 4B, the target areas 301, 401 anticipated by the touch sensor of a touch screen 103 may be calibrated based on the biometric data collected at the biometric sensor 111 of the portable electronic device 100. FIG. 3A illustrates a first sensed area 303 detected by the biometric sensor 111 that is larger than a second sensed area 403 of FIG. 4A that may be detected by the biometric sensor 111. The size of the first and second sensed areas 303, 403 depend upon the finger or object used by the user to contact the biometric sensor 111. For one embodiment, since the first sensed area 303 of FIG. 3A is larger than the second sensed area 403 of FIG. 4A, then the user may have used a larger finger at the first sensed area and a smaller finger at the second sensed area. For another embodiment, a first user having a larger finger may have touched the first sensed area 303 and a second user having a smaller finger may have touched the second sensed area 403. For yet another embodiment, the user at one time period may have pressed harder at the first sensed area 303 and, at a different time period, pressed the second sensed area 403 with less force. In all cases, the biometric data collected by the biometric sensor 111 is used to calibrate the target areas 301, 401 anticipated by the touch sensor of the touch screen 103.

As represented by FIGS. 3B and 4B, the resulting size of the target areas 301, 401 anticipated by the touch sensor of a touch screen 103 may be calibrated based on the size of the sensed areas 303, 403 detected by the biometric sensor 111 of the portable electronic device 100. FIG. 3B illustrates a first target area 301 at the touch sensor that is larger than a second target area 401 at the touch sensor of FIG. 4B. Thus, larger sensed areas 303 at the biometric sensor 111 result in larger target areas 301 anticipated by the touch sensor, whereas smaller sensed areas 403 at the biometric sensor 111 result in smaller target areas 401 anticipated by the touch sensor. By calibrating the touch screen 103 based on the biometric data, falsing at the touch screen 103 may be minimized.

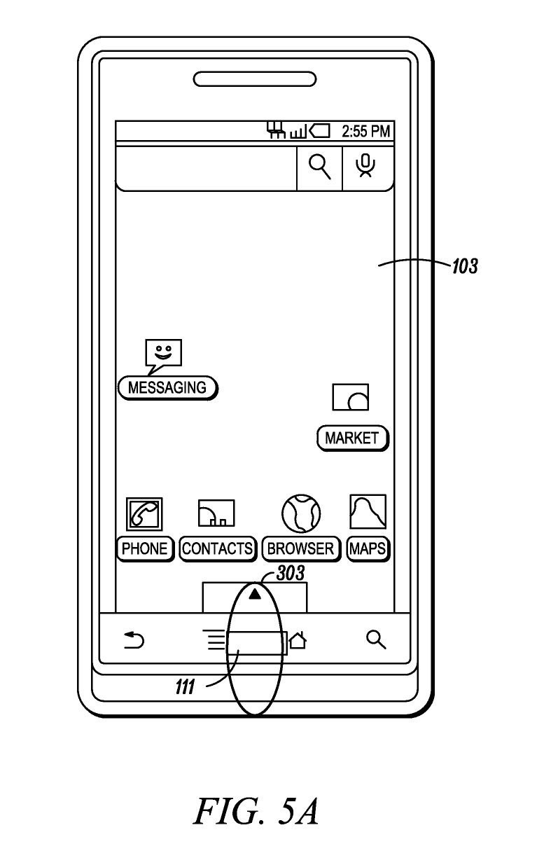

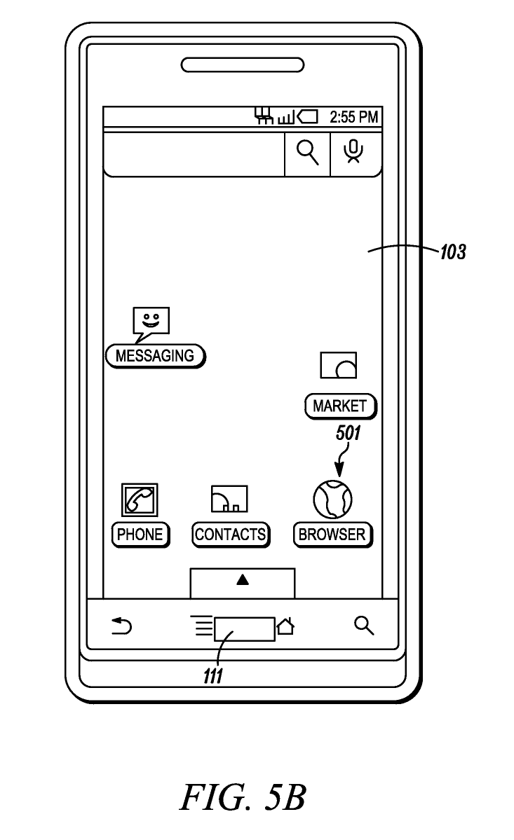

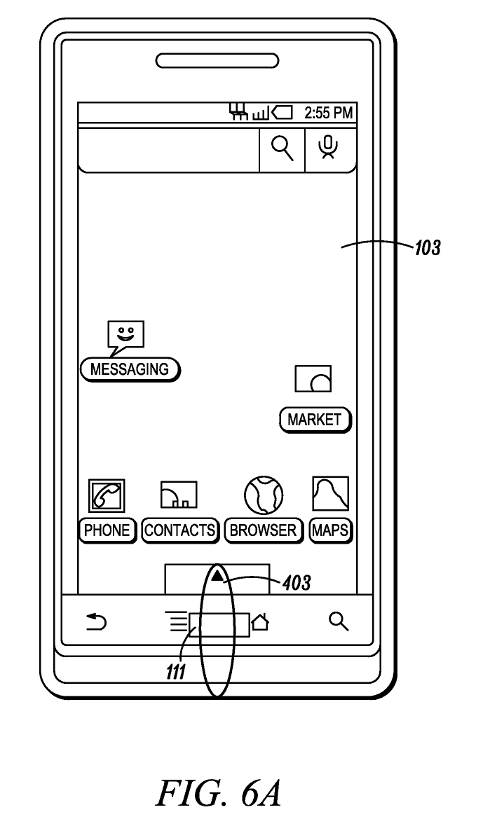

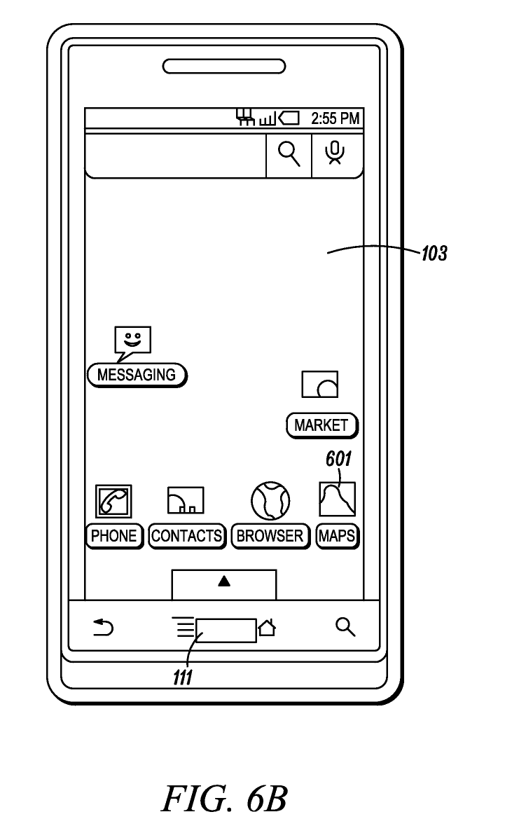

Referring to FIGS. 5A, 5B, 6A and 6B, the icons or images 501, 601 displayed by the touch screen 103 may be calibrated based on the biometric data collected at the biometric sensor 111 of the portable electronic device 100. Similar to FIGS. 3A and 4A, FIG. 5A illustrates a first sensed area 303 detected by the biometric sensor 111 that is larger than a second sensed area 403 of FIG. 6A that may be detected by the biometric sensor 111. As represented by FIGS. 5B and 6B, the resulting size of the icons or images 501, 601 of the touch screen 103 may be calibrated based on the size of the sensed areas detected by the biometric sensor 111 of the portable electronic device 100. FIG. 5B illustrates a first icon or image 501 at the touch screen 103 that is larger than a second icon or image 601 at the touch screen 103 of FIG. 6B. Thus, larger sensed areas 303 at the biometric sensor 111 result in larger icon or image 501 displayed by the touch screen 103, whereas smaller sensed areas 403 at the biometric sensor 111 result in smaller icon or image 601 displayed by the touch screen 103. It is to be understood that for still another embodiment, in addition to the embodiments described above, both the target areas 301 anticipated by the touch sensor of a touch screen 103 and the icons or images 501, 601 displayed by the touch screen 103 may be calibrated based on the biometric data collected at the biometric sensor 111 of the portable electronic device 100.

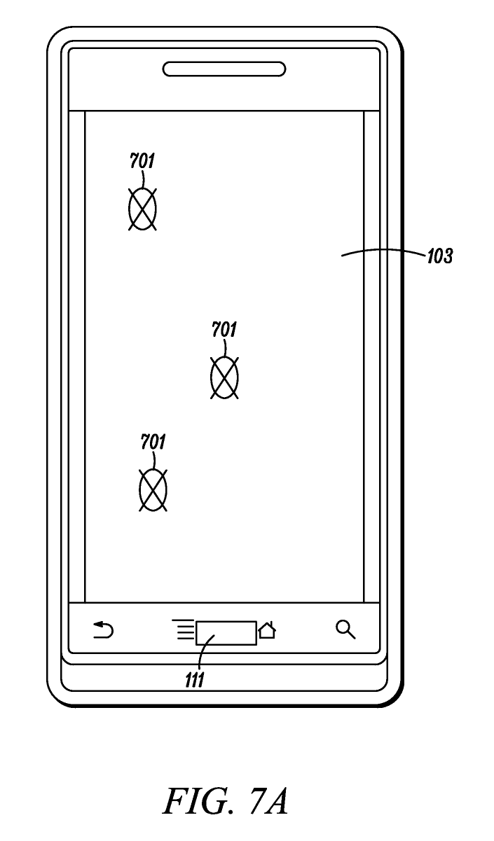

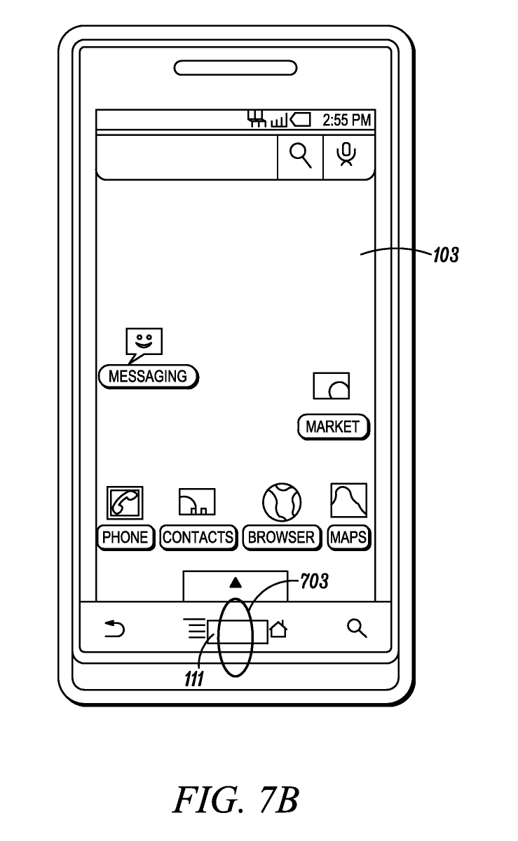

Referring to FIGS. 7A and 7B, the biometric sensor 111 of the portable electronic device 100 may be used as a calibration recorder. As shown in FIGS. 7A, a user may touch one or more locations 701 of the touch sensor of the touch screen 103, by user initiated-action or prompting by the touch screen 103. The contact information collected at the touch sensor may be stored in the memory 205 of the portable electronic device 100. Thereafter, as shown in FIG. 7B, the target areas of the touch sensor and/or icons of the touch screen 103 may be calibrated or adjusted in response to a login procedure by the user. The login procedure may include the biometric sensor 111 detecting user contact 703 and collecting biometric data. In response, the processor 203 may correlate the collected biometric data with the contact information stored at the memory 205, and calibrate or adjust the target areas 301 and/or the icons or images displayed by the touch screen 103 based on the results of the correlation. For example, the target areas 301 and the icons may be calibrated or adjusted based on the familiar finger size and/or fingerprint.

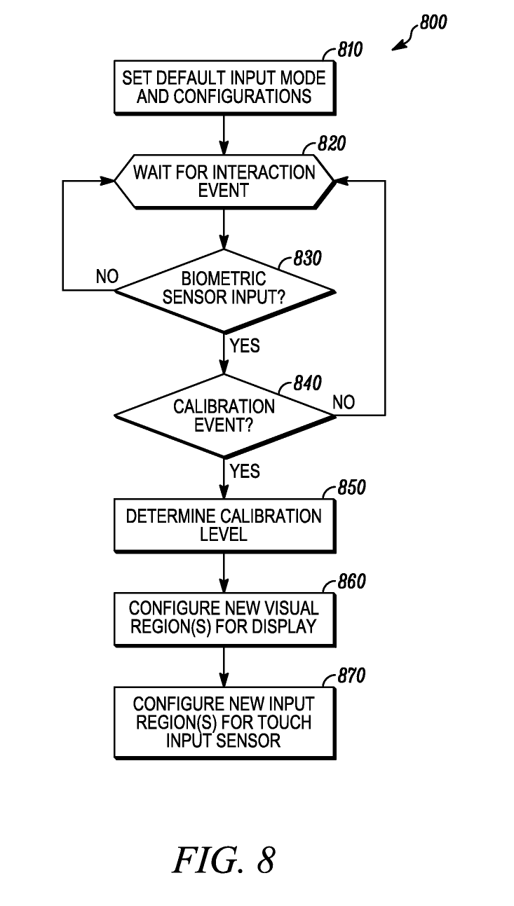

Referring to FIG. 8, there is shown a flow diagram representing an example operation 800 in accordance with the present invention. For this example operation 800, the default input mode and various configurations may be set at step 810. For example, one or more processors 203 of portable electronic device 100 may configure certain components, such as memory 205, output components 207 and input components 209, for default input detection, default input regions, system gain as well as setting or scaling threshold values. Once the default input mode and configurations are set, the input components 209 may wait for an interaction event (i.e., detection of user input) at step 820. When an interaction event is detected, one or more processors 203 may determine whether the interaction event is detected at the biometric sensor 111 at step 830. For example, the biometric sensor 111 may detect a linear dimension of the user input, i.e., a swiping motion across a fingerprint sensor. The processor or processors 203 may also determine whether the interaction event is a calibration event associated with an output component 207 (such as the display of the touch screen) and/or an input component 209 (such as the touch sensor of the touch screen) at step 840. It should be noted that step 840 may occur before, after or concurrently with step 830. It should also be noted that other steps not shown by FIG. 8 may also occur in response to detection of an interaction event or user input, such as an authentication process based on the user input received at the biometric sensor 111. An example of an authentication process includes, but is not limited to, an automated method of verifying a match between a first fingerprint captured by the biometric sensor 111 and a second fingerprint stored at the memory 205. Another example of an additional in step is a device activation or wakeup process when the device is idle or dormant. In such case, the display of the touch screen may be activated in response to the biometric sensor detecting the user input when the display is inactive.

If one or more processors 203 determine that the interaction event is not detected at the biometric sensor 111 or is not associated with an output component 207 and/or an input component 209, then biometric sensor will continue to wait for an interaction event at step 820. If one or more processors 203 determine that the interaction event is detected at the biometric sensor 111 and is associated with an output component 207 and/or an input component 209, then one of processors may determine a calibration level at step 850. For one embodiment, the biometric sensor 111 is a fingerprint sensor capable of detecting linear movement across the fingerprint sensor and capturing a biometric pattern in response to the linear movement. The touch sensor of the touch screen includes a plurality of input regions. In response to detecting the user input, one or more processors calibrate a region size of one or more input regions of the touch sensor based on the size of the user input. For another embodiment, the display of the touch screen includes a plurality of visual regions, and one or more processors calibrate a region size of one or more visual regions of the display based on the size of the user input in response to detecting the user input. For yet another embodiment, one or more processors may calibrate both a first region size of one or more input regions and a second region size of one or more visual regions of the display based on the size of the user input in response to detecting the user input. For the above embodiments, the calibration may be based on a correlation of the user input with a plurality of calibration levels stored at the memory 205 or, in the alternative, a mathematical formula that generates the calibration level based on the user input.

In response to determining the calibration levels, one or more output components 207 may configure one or more new visual regions of the display at step 860. Examples of the resulting new visual regions are illustrated by the icons or images 501, 601 at the touch screen 103 of FIGS. 5B and 6B. In the alternative, in response to determining the calibration levels, one or more input components 209 may configure one or more new input regions of the touch sensor at step 870. Examples of the resulting new input regions are illustrated by the target areas 301, 401 at the touch sensor of FIGS. 3B and 4B.

Various embodiments may benefit from the example operation 800 represented by FIG. 8. During first login, a user may be asked to enter one or more finger to be used for authentication. If the user is not interested in providing fingerprint images for security, then the user may be asked to swipe the finger or fingers expected to be use for navigating the touch display without recording the user's fingerprint. If the user prefers to avoid entering this data as well, then user data may be collected on-the-fly as the user utilizes the biometric sensor 111 for navigation so long as the sensor is enabled. If no data is provided by the biometric sensor 11 or if a biometric sensor 11 is absent on the portable electronic device 100, then the user may be asked to directly touch the sensor for calibration purposes or calibration data is extracted during normal use.

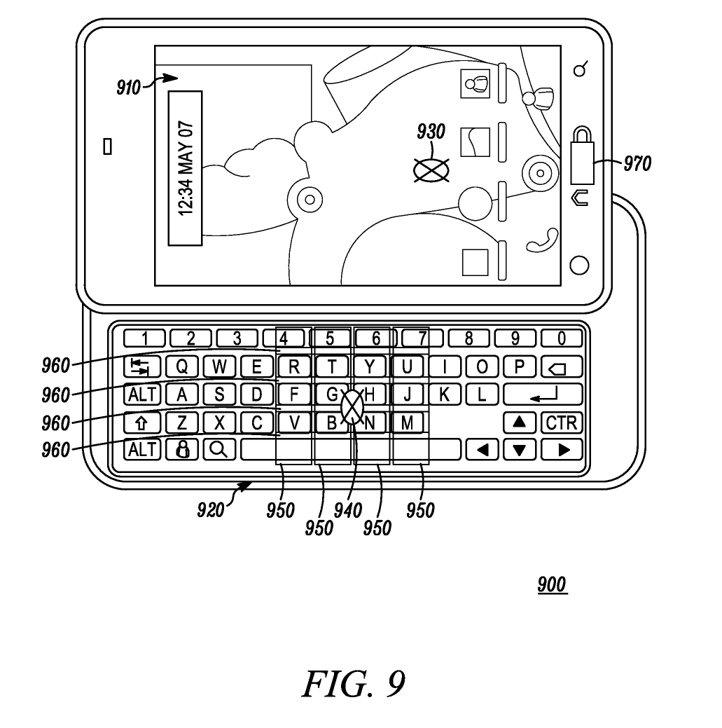

Referring to FIG. 9, there is shown an embodiment 900 in which a touch sensor of the touch screen does not overlay the display of the touch screen. For the particular embodiment 900 shown in FIG. 9, the touch screen includes a first touch sensor 910 that overlays the display, but a second touch sensor 920 is provided adjacent to the display. For example, the first touch sensor 910 is supported by a first housing, and the second touch sensor 920 is supported by a second housing movably attached to the first housing. Thus, as opposed to the open position of the embodiment 900 shown in FIG. 9, the second touch sensor 920 may be on a side of the display opposite the first touch sensor when the embodiment is in its closed position. It is important to note that the concepts of the present invention may also be applied to displays that have a touch screen and/or touch surfaces adjacent to, or otherwise positioned at an outer surface of the device, without the touch screen overlaying the display. If a first touch sensor 910 is provided, then the touch sensor may detect one or more user inputs as represented by contact point 930.

As shown in FIG. 9, the second touch sensor 920 may detect one or more user inputs as represented by contact point 940. For example, the second touch sensor 920 may include a grid of vertical conductors 950 and horizontal conductors 960 orthogonal to the vertical conductors, in which the position or positions of user input may be detected based on the signals sensed by the vertical and horizontal conductors. Thus, in response to detecting a user input at the biometric sensor 970, one or more processors may calibrate a region size of one or more input regions of the second touch sensor 920 based on the size of the user input.

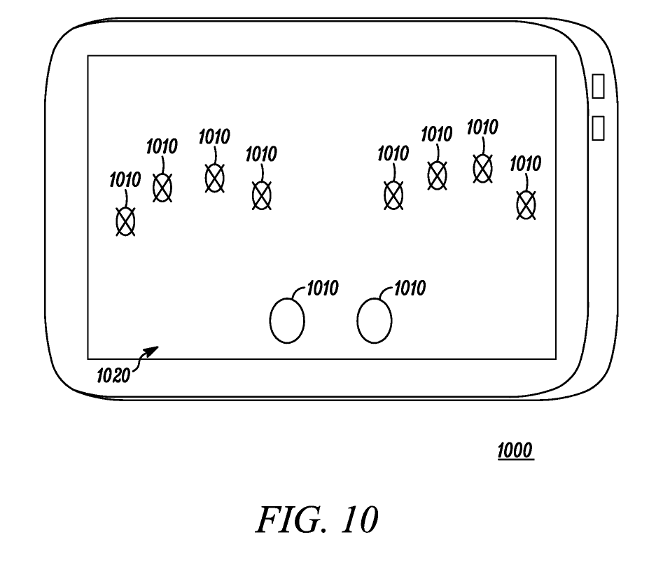

Referring FIG. 10, there is shown an embodiment 1000 in which a biometric sensor, whether provided or not by the portable electronic device, is not utilized for the process represented by this figure. For this particular embodiment 1000, user input of biometric data at one or more contact points 1010 may be detected at the touch sensor 1020 of the touch screen. Calibration of a touch screen sensor or display may be accomplished by biometric data captured or otherwise detected at the touch sensor. For the embodiment 1000, the touch sensor detects a size of the user input. The size of the user input may be linear, such as a width measurement or a height measurement at each contact point 1010, or multi-dimensional, such as the width and height measurements at each contact point. In response to detecting the user input, one or more processors calibrate a region size of one or more input regions of the touch sensor based on the size of the user input. For another embodiment, the display of the touch screen includes a plurality of visual regions, and one or more processors calibrate a region size of one or more visual regions of the display based on the size of the user input (for example, a fingerprint size) in response to detecting the user input. For yet another embodiment, one or more processors may calibrate both a first region size of one or more input regions and a second region size of one or more visual regions of the display based on the size of the user input in response to detecting the user input.

The present invention also has applicability to situations in which devices are used by multiple people, such as a handheld docent in a museum. The quick and accurate calibration can improve the user experience independent of the size, age or other physical differences affecting finger or object size. Such differences in user anatomy are addressed to provide enhanced performance, without compromise, to a statistically-wide swath of the possible finger and object types.

As mobile devices become central repositories of personal and corporate data, security concerns will help drive more of such products to utilize fingerprint authentication. The possibilities of transactional systems may also drive the trend towards an increased deployment of fingerprint readers in touch-enabled products. Fingerprint readers are already on the market with aesthetic covers and lower-profile constructions that most any other navigation device, which should further extend adoption of the technology.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An electronic device having a user interface, the electronic device being capable of calibrating the user interface, the device comprising:
a biometric sensor configured to detect a user input;
a touch screen including a display and a touch sensor; and
at least one processor configured to calibrate at least one of the display or the touch sensor of the touch screen based on the user input detected at the biometric sensor.

2. The electronic device of claim 1, wherein the biometric sensor is a fingerprint sensor capable of detecting linear movement across the fingerprint sensor and capturing a biometric pattern in response to the linear movement.

3. The electronic device of claim 1, wherein the touch sensor is associated with the display and overlays at least part of the display.

4. The electronic device of claim 1, wherein the touch sensor is positioned at an outer surface of the device without overlaying the display.

5. The electronic device of claim 1, wherein the biometric sensor detects a size of the user input.

6. The electronic device of claim 5, wherein the touch sensor includes a plurality of input regions, and the at least one processor calibrates a region size of one or more input regions of the touch sensor based on the size of the user input.

7. The electronic device of claim 5, wherein the display includes a plurality of visual regions, and the at least one processor calibrates a region size of one or more visual regions of the display based on the size of the user input.

8. The electronic device of claim 5, wherein the biometric sensor detects a linear dimension of the user input.

9. The electronic device of claim 1, wherein the display of the touch screen is activated in response to the biometric sensor detecting the user input when the display is inactive.

10. A method of an electronic device for calibration of a touch screen using a biometric sensor, the method comprising:
detecting a user input at the biometric sensor; and
configuring the touch screen in response to detecting the user input at the biometric sensor.

11. The method of claim 10, wherein detecting a user input at the biometric sensor includes detecting linear movement across a fingerprint sensor and capturing a biometric pattern in response to the linear movement.

12. The method of claim 10, wherein the touch screen includes a display and a touch sensor.

13. The method of claim 12, wherein the touch sensor is associated with the display and overlays at least part of the display.

14. The method of claim 12, wherein the touch sensor is positioned at an outer surface of the device without overlaying the display.

15. The method of claim 10, wherein detecting a user input at the biometric sensor includes detecting a size of the user input.

16. The method of claim 15, wherein configuring the touch screen includes configuring a region size of one or more input regions of the touch sensor based on the size of the user input.

17. The method of claim 15, wherein configuring the touch screen includes configuring a region size of one or more visual regions of the display based on the size of the user input.

18. The method of claim 15, wherein detecting a user input at the biometric sensor includes detecting a linear dimension of the user input.

19. The method of claim 1, further comprising authenticating the user input.

20. The method of claim 1, further comprising:
detecting that the display is inactive; and
activating the display of the touch screen in response to detecting the user input and detecting that the display is inactive.
